(19) United States
(12) Patent Application Publication
(10) Pub. No.: US 2024/0265640 A1
(43) Pub. Date: Aug. 8, 2024

(54) METHOD FOR GENERATING A 3D-HEATMAP FOR DISPLAYING A USER'S INTEREST IN A VIRTUAL THREE-DIMENSIONAL OBJECT

(71) Applicant: FECTAR B.V., 's-Hertogenbosch (NL)

(72) Inventors: Laurentius Gerardus Adrianus LENSVELT, 's-Hertogenbosch (NL); Eugène Aloys Adriaan KUIPERS-HOOGVELD, Vught (NL)

(21) Appl. No.: 18/566,350

(22) PCT Filed: Jun. 1, 2022
(86) PCT No.: PCT/NL2022/050299

§ 371 Date: Dec. 1, 2023

(30) Foreign Application Priority Data
Jun. 1, 2021 (NL) 2028370

(51) Int. Cl. G06T 19/00; G06F 3/01

(52) U.S. Cl. CPC G06T 19/003; G06F 3/011; G06T 19/006; G06T 2200/24; G06T 2210/21

(57) ABSTRACT

The invention relates to a method for generating a 3D-heatmap for displaying a user's interest in a virtual object, typically an object in an augmented reality scene. The method comprises the steps of: —generating a virtual 3D-environment with a virtual 3D-object positioned in said virtual 3D-environment, the virtual 3D-object having a virtual 3D-surface; —providing a virtual camera movable within said virtual 3D-environment: —providing display means arranged in the real world for displaying the images captured by the virtual camera: —providing control means arranged in the real world for controlling, within the virtual 3D-environment, the movement of the virtual camera by a user; characterized by —during a time span in which movement of the virtual camera is controlled by the user repeating the steps of: ∘calculating the nearest point of intersection of the optical axis of the virtual camera with the virtual 3D-surface of the virtual 3D-object: ∘storing for each calculated point of intersection the accumulated amount of time during which the calculated point of intersection is intersected by the optical axis of the virtual camera: —after the time span has expired generating in the virtual 3D-environment a 3D-heatmap using the accumulated amount of time for each calculated point of intersection and the calculated point of intersection, wherein the 3D-heatmap is generated directly on the virtual 3D-surface of the virtual 3D-object. A 3D-heatmap obtained with a method of the invention shows the amount of viewing time spent at a specific point on a surface of the virtual object, which is typically indicated by different colors. This allows for a marketeer, manufacturer, developer, teacher, etc. to quickly see how the user (for example a potential buyer or a student) navigates through the virtual environment and which aspects of the virtual object are of most interest for the user.

### FIELD OF THE INVENTION

The invention relates to a method for generating a 3D-heatmap for displaying a user's interest in a virtual 3D-object.

### BACKGROUND ART

A method known in the art to show a virtual environment to a user comprises the steps of:
generating a virtual 3D-environment with a virtual 3D-object positioned in said virtual 3D-environment;
providing a virtual camera movable within said virtual 3D-environment;
providing (real) display means arranged in the real world (e.g. a non-virtual environment) for displaying the images captured by the virtual camera;
providing (real) control means arranged in the real world for controlling, within the virtual 3D-environment, the movement of the virtual camera by the user.

The user can control the virtual camera with some kind of controls, such as a touch input device, a joystick or using a headset mounted with the display means and provided with accelerometers. This allows the user to navigate through the virtual environment and observe the virtual object from a desired perspective.

The image of the virtual environment can also be used as an augmentation of the real world. This allows for moving around in a real world scenery and adding a virtual object thereto. For example, an object that is for sale or an object that has to be studied by a student participating in a course. These techniques are already implemented in apps on smartphones, wherein a manufacturer or a teacher can show a product to a user as if the product is placed in the environment of the user, such as the own living room or a desktop.

When these techniques are used for marketing or teaching purposes, a marketeer, manufacturer, developer, teacher, etc. would like to know which aspects of the virtual 3D-object are of most interest for the user and would like to know how the user navigates through the virtual 3D-environment. This is not possible with the known prior art techniques.

There is therefore a desire for a true 3D-heatmap, e.g. one which contains an aggregation of the user's eye fixations on each part of virtual 3D-object(s) present in a virtual 3D-environment, when the user navigates though the virtual 3D-environment. This would allow that a viewer of the 3D-heatmap can navigate through the virtual 3D-environment and so discover which aspects of the virtual 3D-objects were of most interest for the user. This is fundamentally different from known 3D-heatmaps, where for example a viewer's gaze on a screen is followed, wherein the screen is a perspective projection of 3D geometry onto a 2D plane.

The latter is for example applied in 3D-cartography eye-tracking research, as is described by Lukas Herman et al in “Eye-tracking Analysis of Interactive 3D Geovisualization” (Journal of Eye Movement Research 10(3):2—DOI 10.16910/jemr.10.3.2). Their method can well be applied to geographic maps because most of the time these can be viewed in their entirety from a single viewpoint somewhere above the map. It is not possible for a viewer of the geographic map to navigate over the map and view it from different and self-selected viewpoints, so that for example the viewer's fixation data on otherwise occluded objects can be obtained. Correspondingly, a viewer of the resulting 3D-heatmap can neither perform any such navigation.

### SUMMARY OF THE INVENTION

It is therefore an object of the invention to reduce or even remove the abovementioned disadvantages. This object is achieved according to the invention with a method according to the preamble, which is characterized by:
during a time span in which movement of the virtual camera is controlled by the user repeating the steps of:
   calculating the nearest point of intersection of the line of sight of the virtual camera with the virtual 3D-object; and
   storing for each calculated point of intersection the accumulated amount of time the calculated point of intersection is intersected by the line of sight of the virtual camera;
after the time span has expired, generating in the virtual 3D-environment a 3D-heatmap using the accumulated amount of time for each calculated point of intersection and the calculated point of intersection;
optionally displaying the generated 3D-heatmap on a display means.

### BRIEF DESCRIPTION OF THE DRAWINGS

FIG. 1 shows a first schematic embodiment of the method according to the invention.

FIG. 2 shows a second schematic embodiment of the method according to the invention.

FIG. 3 shows schematically the generated 3D-heatmap for the embodiment of FIG. 2.

FIG. 4 shows a third schematic embodiment of the method according to the invention.

FIG. 5 shows schematically the generated 2D-heatmap and 3D-heatmap for the embodiment of FIG. 4.

FIG. 6 shows the actual 2D-heatmap and 3D-heatmap that were generated for the embodiment of FIG. 4, using the method according to the invention.

FIG. 7 shows an actual 2D-heatmap and 3D-heatmap for a car displayed to a user, viewed from a first viewpoint, generated by using the method according to the invention.

FIG. 8 shows an actual 2D-heatmap and 3D-heatmap for a car displayed to a user, viewed from a second viewpoint, generated by using the method according to the invention.

### DETAILED DESCRIPTION OF THE INVENTION

Elements in the figures are illustrated for simplicity and clarity and have not necessarily been drawn to scale. For example, the dimensions of some of the elements in the figures may be exaggerated relative to other elements to help improve understanding of various exemplary embodiments of the present invention.

In the context of the present invention, by the term ‘user’ is meant a person who makes use of hardware and/or software that is designed to carry out a method of the invention, or a part of such method. For example, a user may make use of a virtual camera, a (real) display means, or a (real) control means. In particular, a user is a person who controls the virtual camera and who performs the movements of the virtual camera on which the 3D-heatmap is based.

In the context of the present invention, by the term ‘viewer’ is meant a person who views a generated 2D- and/or 3D-heatmap, for example a marketeer, manufacturer, developer or a teacher.

Throughout the text, references to the user and the viewer will be made by male words like ‘he’, ‘him’ or ‘his’. This is only for the purpose of clarity and conciseness, as it is understood that female words like ‘she’, and ‘her’ equally apply.

Throughout the text, the term “3D” is used for the sake of conciseness. This term is meant to be equivalent to the term “three-dimensional”. For example, the terms “3D-heatmap”, “3D-object” and “3D-environment” are meant to indicate “three-dimensional heatmap”, “three-dimensional object” and “three-dimensional environment”, respectively. The same equivalency applies when the term “2D” is used. For example, the term “2D-heatmap” is meant to indicate “two-dimensional heatmap”.

A 2D-heatmap is generally known as a data visualization technique that shows magnitude of a phenomenon as color in two dimensions. It uses hue, saturation or luminance to achieve color variation to display various details. This color variation gives visual cues to the readers/viewers about the magnitude of numeric values. When a 2D-heatmap is concerned in the present invention, the two dimensions correspond to a plane in a real or virtual environment, typically a floor.

A 3D-heatmap is in fact an extension of the visualization technique of a 2D-heatmap to three dimensions. It is understood that, generally, 3D-heatmaps may involve different types of data representations. In the context of the present invention, however, a 3D-heatmap is specifically meant to display aggregated fixation data as a heatmap directly on the (virtual) 3D-surface of a virtual 3D-object. Such a ‘surface-based’ 3D-heatmap provides detailed insights into gaze distributions across different surface areas of the object, which reveals which aspects of the object attracted visual interest. This type of 3D-heatmap is inherently the outcome when a method of the invention is carried out—the method can for example not lead to a heatmap involving eye fixations on a perspective projection of 3D geometry onto a 2D plane.

In the context of the present invention, by the term “line of sight” of a (virtual) camera is meant a single line normal to the objective of the camera along which there is some degree of rotational symmetry in that objective. The line is also normal to the image plane. When the virtual camera is applied in a method of the invention, the line of sight typically intersects with the 3D-surface of the virtual 3D-object at a position that is in the center of the camera's field of view.

An term equivalent to the “line of sight” is the “optical axis” of a (virtual) camera, for which the same definition applies as for the line of sight elaborated hereabove. The term optical axis is known to the skilled person, e.g. as a line normal to the image plane and coinciding with an axis of rotational symmetry in the objective of the (virtual) camera. The term is also known to the skilled person as the “principal axis” of a (virtual) camera.

In the context of the present invention, a user and a viewer are understood to be a real entity existing in the real world, such as a person or an animal.

In the context of the present invention, it is understood that “a user's interest” as displayed in a 3D-heatmap may also be a user's assumed interest, since a 3D-heatmap is in fact a representation of certain activities of a user, from which an interest of the user can be assumed (by e.g. a marketeer or a teacher).

It is obvious that the calculations can be performed in real time during the user session, but can also be calculated after the user session has ended. In such a case, data on the movement and orientation of the virtual camera is stored temporarily and used for the calculations at a later time.

In a method of the invention, the virtual 3D-object is understood to have a virtual 3D-surface. The nearest point of intersection of the optical axis of the virtual camera with the virtual 3D-object in fact occurs at that virtual 3D-surface. Also, the generation of the 3D-heatmap is performed directly on the virtual 3D-surface of the virtual 3D-object, so that that virtual 3D-surface can be considered to be ‘coated’ with the 3D-heatmap.

With the method according to the invention, it is possible to show afterwards which parts of the virtual object received the most (visual) attention. This is achieved by registering which point on the virtual object was intersected by the optical axis of the camera and how long this point was the center of attention.

After the user has closed the session of roaming the virtual environment, the time for each point of intersection is used to generate a 3D-heatmap. A 3D-heatmap shows the amount of viewing time spent at a specific point by different colors or different grey-shades. Such point is typically a position on a surface of the virtual object, for example on the bodywork of a displayed car, or even of the interior such as the dashboard.

This allows for a marketeer, manufacturer, developer, teacher or other viewer to quickly see which parts of the virtual object have been the center of attention and which parts were of less or no interest for the user.

A preferred embodiment of the invention further comprises the steps of:
defining a cone shaped envelope of lines having the optical axis of the virtual camera as center line;
during a time span in which movement of the virtual camera is controlled by the user repeating the steps of:
   calculating the nearest point of intersection of each of the lines of the cone shape with the virtual object; and
   storing for each calculated point of intersection the accumulated amount of time multiplied by a ratio depending on the distance from the optical axis for which the calculated point of intersection is intersected by the respective line.

The ratio is typically smaller than 1 and decreases when the distance to the optical axis increases.

Another preferred embodiment of the invention further comprises the steps of:
defining a cone shaped envelope of lines having the optical axis of the virtual camera as center line, the cone shaped envelope having a half cone angle which is defined as the angle between the cone's axis of rotational symmetry and its sides;
during a time span in which movement of the virtual camera is controlled by the user repeating the steps of:
   calculating the nearest point of intersection of each of the lines of the cone shape with the virtual object; and
   storing for each calculated point of intersection the accumulated amount of time multiplied by a number that depends on the half cone angle.
after the time span has expired generating in the virtual 3D-environment a 3D-heatmap using the accumulated amount of time for each calculated point of intersection and the calculated point of intersection.

The number is typically smaller than 1, in particular between 0 and 1, and decreases when the distance to the optical axis increases.

When the optical axis of the virtual camera is fixed on a single point on the virtual object, the user can still see the surrounding part of the virtual object. So, the point of intersection of the optical axis with the object may not be the exact point of interest of the user. By also calculating the intersection point of the cone shaped envelope of lines and taking into account the half cone angle (or the distance to the optical axis of the virtual camera), any deviations between the optical axis of the camera and the viewing direction of the user are taken into account.

Yet another embodiment of the method according to the invention further comprises the steps of:
generating in the virtual environment a virtual floor;
during the time span in which movement of the virtual camera is controlled by the user in addition repeating the steps of:
   calculating the point of intersection of the normal to the virtual floor with the virtual camera; and
   storing for each calculated point of intersection the accumulated amount of time the calculated point of intersection is intersected by the normal to the virtual floor.
after the time span has expired, generating a 2D-heatmap using the accumulated amount of time the calculated point of intersection is intersected by the normal to the virtual floor.

Preferably, the 2D-heatmap of the intersection of the normal to the virtual floor is combined with the 3D-heatmap generated based on the optical axis of the virtual camera. In such case, the 2D-heatmap is displayed in a 3D-environment.

This preferred embodiment also allows to obtain information on the virtual position of the user standing on a virtual floor, assuming that the user holds the virtual camera. Registering the amount of time the user spent on certain positions provides input for the 2D-heatmap, which shows where the user was virtually standing in a virtual space while looking at the virtual object in the virtual space. This additional information provides further insight for a marketeer, manufacturer, developer, teacher, or the like.

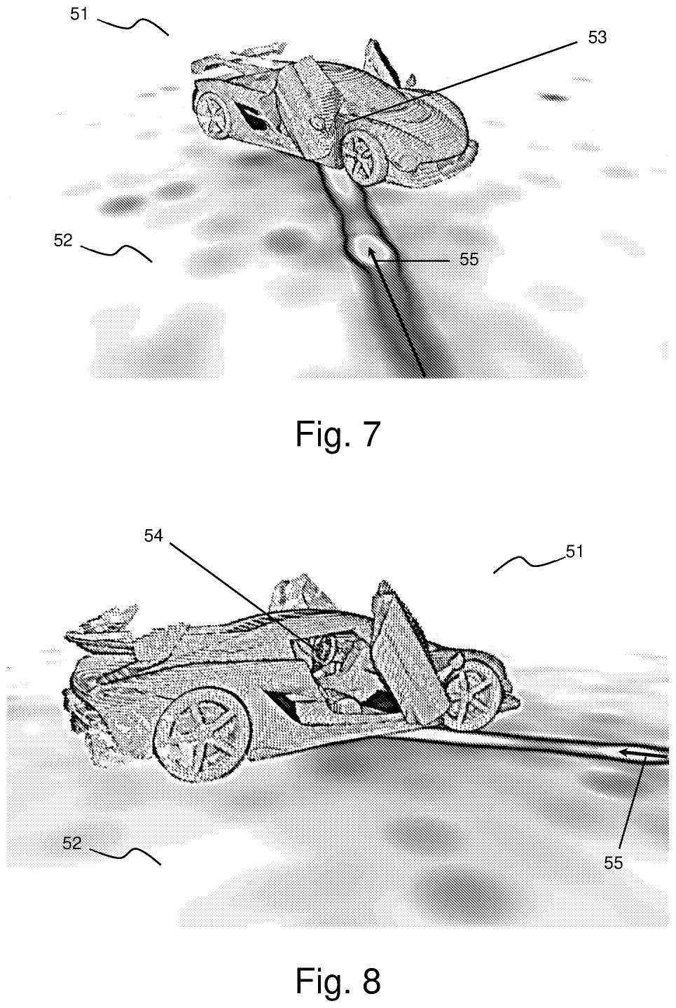

This demonstrates that a method of the invention allows the generation of heatmaps in virtual 3D-environments wherein some objects (or parts thereof) are occluded. The user can navigate in a virtual 3D-environment to discover objects (or parts thereof) that were not visible in first instance. The same holds for the viewer. This advantage of a method of the invention is illustrated in FIGS. 7 and 8, which is further explained in the last part of this description.

In another preferred embodiment of the method according to the invention, the display means augment a view of the real world and wherein the orientation and position of the display means is linked to the orientation and position of the virtual camera.

With this preferred embodiment, the invention is applied in an augmented reality application, where a virtual object is shown within a view of the real world. This improves the experience of the user, while after the expiration of the time span a viewer can see on the generated 3D-heatmap, which parts of the virtual object were the most looked at.

In another embodiment of the method according to the invention, the control means comprise at least one accelerometer and optionally a GPS sensor, to obtain a position and orientation of the control means. With the acceleration measured by the accelerometers, the displacement and rotation of the control means can be calculated and this can be used to set the displacement and rotation of the virtual camera in the virtual environment.

Preferably, the control means are fixedly arranged to the display means. In such case, they are usually unified to form one device such as a smart phone, tablet or head-mounted device such as VR glasses.

Using the control means, especially with at least one accelerometer and optionally a GPS sensor, the user can simply move the display means to control the virtual camera. This provides for a natural control of the virtual camera.

In such augmented reality application, the real position of a user with respect to a virtual object shown within a view of the real world can also be visualized in a 2D-heatmap of the type that is described above. This is accomplished by letting the virtual floor coincide with the floor in the real world. In such case, the user holds the display means and the control means, which are typically combined in one device such as a smart phone, tablet or head-mounted device such as VR glasses. The trajectory of a user in the real world can then be recorded, from which the 2D-heatmap can be generated.

The 2D- and 3D-heatmaps obtained with a method of the invention can be based on the data of a single user or by the data of a plurality of users. In the latter case, the data generated by two or more users are combined to generate a single 2D- or 3D-heatmap. This allows for generating heatmaps based on a large population of users. Such population may comprise at least 2 users, at least 10 users, at least 100 users, at least 1.000 users, at least 10.000 users, at least 100.000 users, or at least 1.000.000 users. FIGS. 7 and 8 for example display a combined 2D- and 3D-heatmap for a plurality of users, wherein the number of users is 500.

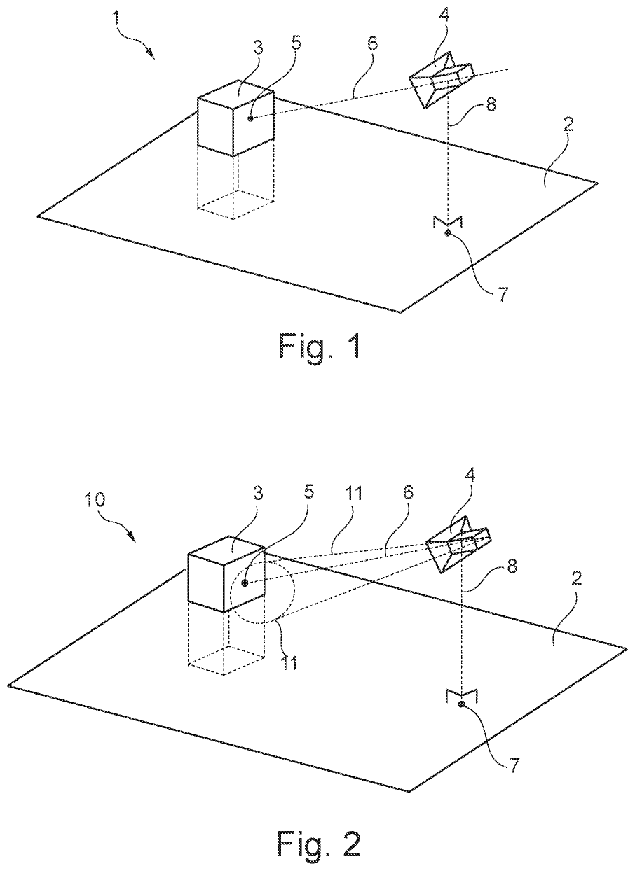

FIG. 1 shows schematically a virtual environment 1 for the method according to the invention. A virtual floor 2, a virtual object 3 and a virtual camera 4 is positioned in the virtual environment 1. The image captured by the virtual camera 4 is displayed on a display in the real world and the virtual camera 4 can be moved and orientated in the virtual environment by controls available for the user in the real world, which techniques are commonly known in the prior art.

While the user is controlling the camera 4 and looking at the image of the virtual camera 4 displayed on the display in the real world, the method according to the invention calculates the nearest point of intersection 5 of the optical axis 6 of the virtual camera 4 with the virtual object 3. Also the point of intersection 7 of the normal 8 to the virtual floor 2 with the virtual camera 4 is calculated.

The time a user maintains the virtual camera 4 in a position and the point of intersection 5 on the virtual object 3 as well as the point of intersection 7 on the virtual floor is stored, such that after termination of the user session a 3D-heatmap can be generated.

FIG. 2 shows a second embodiment of the method according to the invention, which is similar to the embodiment shown in FIG. 1. Similar parts are designated with the same reference signs.

In addition to the embodiment of FIG. 1, a cone shaped envelope of lines 11 is defined having the optical axis 6 of the virtual camera 4 as center line. Of each of these lines 11 a point of intersection with the virtual object 3 is calculated. A time value is registered for the point of intersection dependent on the distance of the point of intersection to the optical axis 6. So, a point close to the optical axis 6 will obtain almost the same time value as the point of intersection 5 of the optical axis 6, while a point more distant from the optical axis 6 will obtain a smaller amount of time.

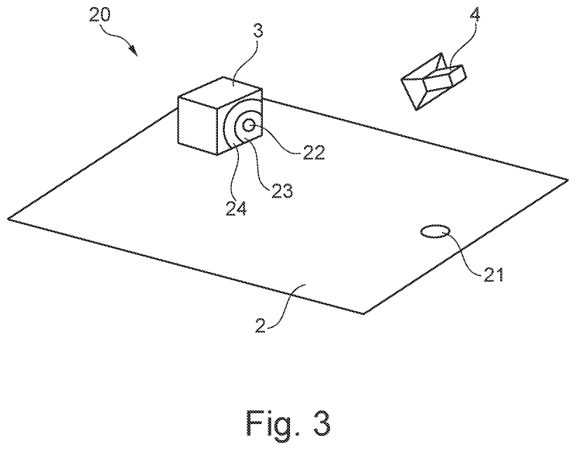

FIG. 3 schematically shows the 3D-heatmap 20 generated from the time values of the point of intersection. Zone 21 depicts in a color the time, the virtual camera 4 stayed in the shown position. On the virtual object 3 a color pattern 22, 23, 24 is depicted, which shows the time the optical axis stayed on the point of intersection 5 of the optical axis 6 of the camera 4 and the surrounding zones 23, 24 show the time as a ratio of the distance to the optical axis.

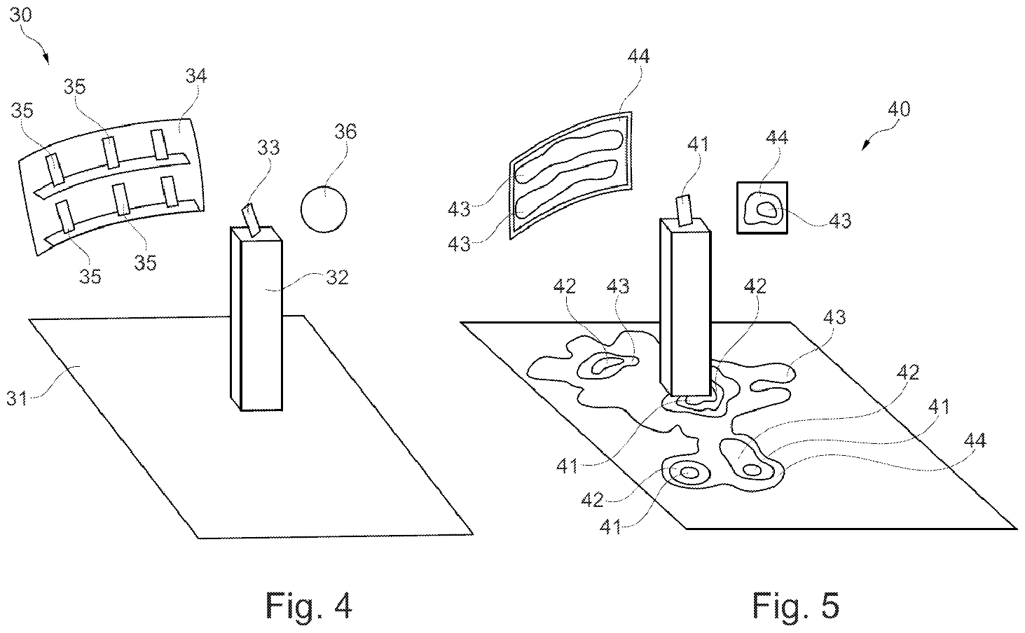

FIG. 4 shows a third schematic view of a virtual environment 30 with a virtual floor 31 on which a pedestal 32 is positioned with a smartphone 33. A display 34 with further smartphones 35 is positioned behind the pedestal 32 and a virtual buy-button 36 is positioned next to the pedestal 32.

As explained in relation to FIGS. 1 and 2, a user can position and orient a virtual camera (not shown) to look at the virtual smartphone 33, 35 and if desired push the buy-button 36.

FIG. 5 schematically shows a 3D-heatmap 40 generated by the method, which calculates the point of intersection of the optical axis of the virtual camera with the objects 32, 33, 34, 35, 36 in the virtual environment. In the same 3D-environment, FIG. 5 also shows a 2D-heatmap of the position of the user standing on the virtual floor, which is obtained as the projection of the virtual camera on the virtual floor 31. As a result, a pattern of different colors is generated as a 3D-heatmap, which shows which objects 32, 33, 34, 35, 36 were of the most interest for the user. In addition, a pattern of different colors is generated as a 2D-heatmap in the 3D-environment of the 3D-heatmap, showing the positions that were most occupied by the user within the virtual environment.

The zones 41, 42, 43, 44 show the amount of time, where zone 41 represents the highest time value, while zone 44 represents the lowest time value.

As a result, a marketeer can quickly see how the user behaved in the virtual environment 30, e.g. the user's movements, gazing time, distance, speed, interaction, and even particular gestures (kneeling, raising arms and the like).

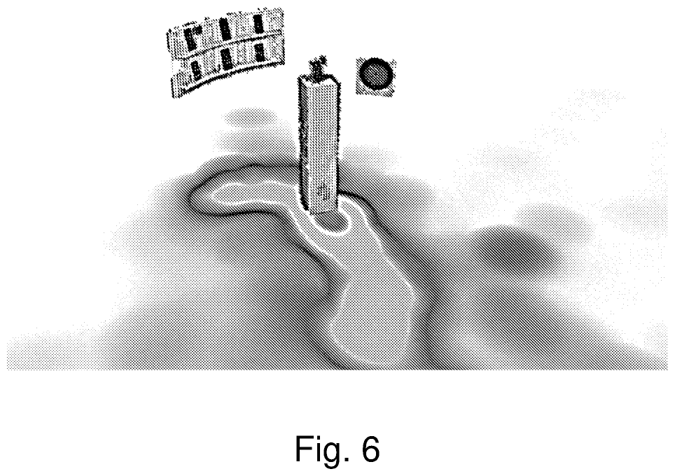

The schematic 2D- and 3D-heatmap 40 of FIG. 5 is reproduced in FIG. 6 as the actual 2D- and 3D-heatmap obtained as the actual output of the method of the invention.

FIGS. 7 and 8 also represent actual 2D- and 3D-heatmaps obtained by the method of the invention. The heatmaps in both figures relate to the same virtual 3D-environment and are obtained from the same user sessions. The heatmaps are an accumulation of 500 user sessions, wherein all users started at the same position. The virtual 3D-environment shows a car 51 on a floor 52. The 2D- and 3D-heatmaps displayed in FIG. 7 are the same as those in FIG. 8, except that they are presented from two different viewpoints—a first viewpoint in FIG. 7 and a second viewpoint in FIG. 8. The surfaces of the car 51 are ‘covered’ with a 3D-heatmap, displaying which parts of the car received much visual attention and which didn't (although it is realized that this may not be well-derivable from these black and white car drawings, because the lines and dots that provide 3D-perspective to the car's bodywork compete substantively with the heatmap overlay that was originally colored). In FIG. 7, for example, it is shown that the bodywork 53 near the windshield received particularly high attention. This can be however not be derived from FIG. 8 since that bodywork 53 is occluded. Conversely, FIG. 8 shows that there was quite some attention to the car's interior at the driver's seat 54. FIG. 7, however, can't confirm this, since it has no view on the car's interior.

The floor 52 contains an overlay of the 2D-heatmap that represents the movement of the users during the 500 user sessions. Also this 2D-heatmap is of course identical in FIGS. 7 and 8, it is only viewed from two different viewpoints. Each session started with the user at the same position, which is diagonally in front of the car's right side (as experienced by a driver in the driver's seat). This starting position is just outside the displayed floor, so it is not visible in both figures. The walking path from the starting point to the car is however clearly visible in both figures, as indicated with the arrow 55 in FIG. 7 and FIG. 8. Both arrows end at approximately the same position on the floor, which is a spot with a lot of ‘heat’ (hotspot), indicating that this is a preferred position by many of the users to stand still and observe the car 51. The heatmap further tells a viewer that users continue their path in the same direction towards the car. The hotspot that is indicative of this, is right next to the car. It even extends to floor locations under the car. This is possible since the car is a virtual object, so that a viewer cannot be blocked by the car. Given the high attention to the car's interior as indicated by the 3D-heatmap, many users likely continue their path and walk ‘through’ the car until they arrive at the driver's seat (this was easily confirmed by ‘removing’ the car from the 2D-heatmap, but this is not shown in the Figures). Other user-preferred standing positions around the car are also visible on the 2D-heatmap of the floor 52 (grey shapes).

1. Method for generating a 3D-heatmap for displaying a user's interest in a virtual 3D-object, which method comprises the steps of:
generating a virtual 3D-environment with a virtual 3D-object positioned in said virtual 3D-environment, the virtual 3D-object having a virtual 3D-surface;
providing a virtual camera movable within said virtual 3D-environment;
providing display means arranged in the real world for displaying the images captured by the virtual camera;
providing control means arranged in the real world for controlling, within the virtual 3D-environment, the movement of the virtual camera by a user;
wherein
during a time span in which movement of the virtual camera is controlled by the user repeating the steps of:
calculating the nearest point of intersection of the optical axis of the virtual camera with the virtual 3D-surface of the virtual 3D-object; and
storing for each calculated point of intersection the accumulated amount of time during which the calculated point of intersection is intersected by the optical axis of the virtual camera;
after the time span has expired generating in the virtual 3D-environment a 3D-heatmap using the accumulated amount of time for each calculated point of intersection and the calculated point of intersection.

2. Method according to claim 1, wherein the 3D-heatmap is generated on the virtual 3D-surface of the virtual 3D-object.

3. Method according to claim 1, wherein the method is followed by displaying the generated 3D-heatmap on a display means, for example the display means arranged in the real world for displaying the images captured by the virtual camera.

4. Method according to claim 1, further comprising the steps of:
defining a cone shaped envelope of lines having the optical axis of the virtual camera as center line, the cone shaped envelope having a half cone angle which is defined as the angle between the cone's axis of rotational symmetry and its sides;
during a time span in which movement of the virtual camera is controlled by the user repeating the steps of:
calculating the nearest point of intersection of each of the lines of the cone shape with the virtual object; and
storing for each calculated point of intersection the accumulated amount of time multiplied by a number that depends on the half cone angle.
after the time span has expired generating in the virtual 3D-environment a 3D-heatmap using the accumulated amount of time for each calculated point of intersection and the calculated point of intersection.

5. Method according to claim 4, wherein the number is between 0 and 1 and decreases when the half cone angle increases.

6. Method according to claim 4, wherein the 3D-heatmap is generated on the virtual 3D-surface of the virtual 3D-object.

7. Method according to claim 4, wherein the method is followed by displaying the generated 3D-heatmap on a display means, for example the display means arranged in the real world for displaying the images captured by the virtual camera.

8. Method according to claim 1, further comprising the steps of:
generating in the virtual environment a virtual floor;
during the time span in which movement of the virtual camera is controlled by the user in addition repeating the steps of:
calculating the point of intersection of the normal to the virtual floor with the virtual camera; and
storing for each calculated point of intersection the accumulated amount of time during which the calculated point of intersection is intersected by the normal to the virtual floor;
after the time span has expired generating a 2D-heatmap using the accumulated amount of time during which the calculated point of intersection is intersected by the normal to the virtual floor.

9. Method according to claim 8, wherein the 2D-heatmap is generated on the virtual floor.

10. Method according to claim 8, wherein the method is followed by displaying the generated 2D-heatmap on a display means, for example the display means arranged in the real world for displaying the images captured by the virtual camera.

11. Method according to claim 1, wherein the display means augment a view of the real world and wherein the orientation and position of the display means is linked to the orientation and position of the virtual camera.

12. Method according to claim 1, wherein the control means comprise at least one accelerometer and optionally a GPS sensor, to obtain a position and orientation of the control means.

13. Method according to claim 11, wherein the control means are fixedly arranged to the display means.
